(19) United States
(12) Patent Application Publication
(10) Pub. No.: US 2015/0056400 A1
(43) Pub. Date: Feb. 26, 2015

(54) METHOD AND ARTICLE FOR DECORATING NON-COMPATIBLE MATERIALS

(71) Applicant: High Voltage Graphics, Inc., Fort Collins, CO (US)

(72) Inventor: Louis Brown Abrams, Fort Collins, CO (US)

(21) Appl. No.: 14/465,655

(22) Filed: Aug. 21, 2014

Related U.S. Application Data
(60) Provisional application No. 61/868,355, filed on Aug. 21, 2013.
(60) Provisional application No. 61/870,528, filed on Aug. 27, 2013.
(60) Provisional application No. 61/876,529, filed on Sep. 11, 2013.
(60) Provisional application No. 61/878,935, filed on Sep. 17, 2013.
(60) Provisional application No. 61/888,853, filed on Oct. 9, 2013.

(51) Int. Cl. B44C 1/26

(52) U.S. Cl. CPC B44C 1/26
USPC 428/67; 156/252

(57) ABSTRACT

The disclosure generally relates to decorative inlays, and, more particularly, to decorative inlays having a common material and an inlay that are one or both of not adhered to one another and not mechanically interconnected to one another. Moreover, in opposition to decorative inlays of the prior art where a backing material supports the common material and the inlay material, decorative inlays are disclosed having a backing material supported by the common material and inlay material.

### CROSS REFERENCE TO RELATED APPLICATIONS

The present application claims the benefits of U.S. Provisional Application Ser. Nos. 61/868,355 with a filing date of Aug. 21, 2013, 61/870,528 with a filing date of Aug. 27, 2013, 61/876,529 with a filing date of Sep. 11, 2013, each entitled “Method and Article for Decorating Vinyl Materials” and 61/878,935 with a filing date of Sep. 17, 2013, and 61/888,853 with a filing date of Oct. 9, 2013 both entitled “Method and Article for Decorating Non-Compatible Materials,” all of which are incorporated herein by this reference in their entirety.

### FIELD OF THE APPLICATION

This disclosure relates generally to decorative inlays, and, more particularly, is directed towards decorative inlays having a common material and an inlay that are one or both of not adhered to one another and not mechanically interconnected to one another.

### BACKGROUND

Decorative inlays 100 of the prior art (FIGS. 1-3) have a common material 101 and an inlay material 102. In some prior art decorative inlay configurations, the inlay material 102 is adhered to the common material 101 by adhesive 103 (FIG. 1). In such configurations, the adhesive 103 is positioned between the inlay material 102 and the common material 101. Generally, the adhesive 103 forms a portion of decorative inlay viewable surface 105.

In other prior art decorative inlay configurations, the inlay material 102 and common material 101 are mechanically interlocked and/or joined one to the other (FIG. 2). The inlay material 102 and common material 101 are mechanically interlocked along common mating surface 101a and inlay mating surface 102a. Adhesive 103 (not depicted) may or may not be positioned between the common mating surface 101a and the inlay mating surface 102a.

In yet other prior art decorative inlay configurations, the inlay material 102 is positioned adjacent to and in contact with common material 101 (FIG. 3). The contacting of the inlay material 102 and the common material 101 is free of an adhesive 103 and any mechanical interlocking. Moreover, the decorative inlay 100 of FIG. 3 includes a base material 109. The base material 109 is adhered to the inlay material 102 and the common material 101 by adhesive 108. The decorative inlay 100 has an outer perimeter 107. The base material 109 extends to at least to the outer perimeter 107. Typically, the base material 109 extends beyond the outer perimeter 107. In some configurations, the decorative inlay 100 of FIG. 3 is an appliqué applied to base material 109. Non-limiting examples of base material 109 are a floor (comprising concrete, wood, stone, or composite material), a textile (such as, a woven material, a knitted item, or a non-woven item), or a hard surface (such as, a metallic structure or member, wooden structure or member, or rigid composite material).

There is a need for decorative inlays constructed free of mechanically interlocking of the insert and common materials and free of an adhesive position between the inlay material and the common material. For example, some insert and common materials are difficult to or of incapable of being mechanically interlocked. Furthermore, mechanically interlocking of the insert and common materials introduces stiffness or rigidity to the decorative inlay.

Furthermore, there is a need for decorative inlays lacking an adhesive positioned between the insert and common materials. For example, some insert and common materials are difficult to or incapable of being adhesively joined. Moreover, the adhesive joining of the insert and the common materials typically introduces stiffness or rigidity to the decorative inlay about the adhesive joint.

A need exists for decorative inlays comprising insert and common materials cannot be easily adhesively joined, mechanically joined, or both. A non-limiting example includes inserts comprising polymeric materials or metalized materials. A non-limiting example of common material includes leather.

There is also a need for a decorative insert having backing material that extends over some, but not all, of the common material and does not extend to the outer perimeter of decorative inlay. Having the backing material extend over some, but not all, of the common material one or more of decreases bulkiness, reduces rigidity, and expands design features of decorative inserts.

### SUMMARY

These and other needs are addressed by the various embodiments and configurations of the present invention.

In accordance with some embodiments is an article having a backing material, a common material, and an inlay material. Typically, the common material is adhered to the backing material and supports the backing material. Moreover, at least one of the following is true about the article: (i) the inlay material and common material are not adhered to one another and (ii) the inlay material and common material are not mechanically interconnected to one another.

Some embodiments include an article having a backing material, a common material, and an inlay material that is a polymeric material. Typically, the common material is adhered to the backing material and supports the backing material. Moreover, at least one of the following is true about the article: (i) the inlay material and common material are not adhered to one another and (ii) the inlay material and common material are not mechanically interconnected to one another.

Some embodiments include an article having a backing material, a common material, and an inlay material that is a radio frequency molded polymeric material. Typically, the common material is adhered to the backing material and supports the backing material. Moreover, at least one of the following is true about the article: (i) the inlay material and common material are not adhered to one another and (ii) the inlay material and common material are not mechanically interconnected to one another.

Some embodiments include an article having a backing material, a common material that is naturally occurring animal skin, and an inlay material. Typically, the common material is adhered to the backing material and supports the backing material. Moreover, at least one of the following is true about the article: (i) the inlay material and common material are not adhered to one another and (ii) the inlay material and common material are not mechanically interconnected to one another.

Some embodiments include an article having a backing material, a common material that is leather, and an inlay material. Typically, the common material is adhered to the backing material and supports the backing material. Moreover, at least one of the following is true about the article: (i) the inlay material and common material are not adhered to one another and (ii) the inlay material and common material are not mechanically interconnected to one another.

In accordance with some embodiments is an article having a backing material, a common material having one or more voids, and an inlay material positioned in the one or voids. Typically, the common material is adhered to the backing material and supports the backing material. Moreover, at least one of the following is true about the article: (i) the inlay material and common material are not adhered to one another and (ii) the inlay material and common material are not mechanically interconnected to one another.

In accordance with some embodiments is an article having a backing material, a common material having a common material thickness, and inlay material having an inlay material thickness. Typically, the common material thickness and the inlay thickness are about equal. Generally, the common material is adhered to the backing material and supports the backing material. Moreover, at least one of the following is true about the article: (i) the inlay material and common material are not adhered to one another and (ii) the inlay material and common material are not mechanically interconnected to one another.

In accordance with some embodiments is an article of decoration having an inlay material, a common material having one or more voids containing the inlay material, and a backing material. Typically, the inlay material is adhered to a first portion of the backing material and a second portion of the backing material is adhered to some, but not all, of the common material. Furthermore, at least one of the following is true about the article of decoration: (i) the inlay material and common material are not adhered to one another and (ii) the inlay material and common material are not mechanically interconnected to one another.

Some embodiments include an article of decoration having an inlay material that is a polymeric material, a common material having one or more voids containing the inlay material, and a backing material. Typically, the inlay material is adhered to a first portion of the backing material and a second portion of the backing material is adhered to some, but not all, of the common material. Furthermore, at least one of the following is true about the article of decoration: (i) the inlay material and common material are not adhered to one another and (ii) the inlay material and common material are not mechanically interconnected to one another.

Some embodiments include an article of decoration having an inlay material that is a radio frequency molded polymeric material, a common material having one or more voids containing the inlay material, and a backing material. Typically, the inlay material is adhered to a first portion of the backing material and a second portion of the backing material is adhered to some, but not all, of the common material. Furthermore, at least one of the following is true about the article of decoration: (i) the inlay material and common material are not adhered to one another and (ii) the inlay material and common material are not mechanically interconnected to one another.

Some embodiments include an article of decoration having an inlay material, a common material that is a naturally occurring animal skin and has one or more voids containing the inlay material, and a backing material. Typically, the inlay material is adhered to a first portion of the backing material and a second portion of the backing material is adhered to some, but not all, of the common material. Furthermore, at least one of the following is true about the article of decoration: (i) the inlay material and common material are not adhered to one another and (ii) the inlay material and common material are not mechanically interconnected to one another.

Some embodiments include an article of decoration having an inlay material, a common material that is leather and has one or more voids containing the inlay material, and a backing material. Typically, the inlay material is adhered to a first portion of the backing material and a second portion of the backing material is adhered to some, but not all, of the common material. Furthermore, at least one of the following is true about the article of decoration: (i) the inlay material and common material are not adhered to one another and (ii) the inlay material and common material are not mechanically interconnected to one another.

Some embodiments include an article of decoration having an inlay material, a common material that is leather and has one or more voids containing the inlay material, and a backing material. Typically, the inlay material is adhered to a first portion of the backing material and a second portion of the backing material is adhered to some, but not all, of the common material. Generally, the common material has a common material thickness and the inlay material has an inlay material thickness. Moreover, the common material thickness and inlay material thickness are about equal. Furthermore, at least one of the following is true about the article of decoration: (i) the inlay material and common material are not adhered to one another and (ii) the inlay material and common material are not mechanically interconnected to one another.

The above embodiments can be taken alone or in combination with any one or more of the below first, second, third, fourth, fifth and sixth embodiments.

A first embodiment includes an inlay material that is a polymeric material. In some embodiments, the inlay material that is a radio frequency molded polymeric material.

A second embodiment includes the common material having one or more voids. Furthermore, positioned in the one or more voids is the inlay material.

A third embodiment includes the common material having a common material thickness and the inlay material has an inlay material thickness. Furthermore, a fourth embodiment includes the common material thickness and inlay material thickness being about equal.

A fifth embodiment includes the common material is a naturally occurring animal skin. Furthermore, a sixth embodiment includes the common material being leather.

These and other advantages will be apparent from the disclosure of the invention(s) contained herein.

In accordance with some embodiments is a method of making a decorative inlay by providing a inlay material, a common material, an adhesive and a backing material; providing a committed set of instructions, where the committed set of instructions guides a cutting device; creating one or more voids of desired size and shape in the common material; inserting the inlay material into the one or more voids; and adhering the backing material to the inlay and at least some, but not all, of the common material by the adhesive, wherein at least one of the following is true: (i) the inlay material and common material are not adhered to one another and (ii) the inlay material and common material are not mechanically interconnected to one another.

Some embodiments include, a method of making a decorative inlay by providing a inlay material having a desired pattern, a common material, an adhesive and a backing material; determining the desired pattern and committing and translating the desired pattern into a committed set of instructions, where the committed set of instructions guides a cutting device; creating one or more voids of desired size and shape in the common material; inserting the inlay material into the one or more voids; and adhering the backing material to the inlay and at least some, but not all, of the common material by the adhesive, wherein at least one of the following is true: (i) the inlay material and common material are not adhered to one another and (ii) the inlay material and common material are not mechanically interconnected to one another.

Some embodiments include, a method of making a decorative inlay by providing a inlay material, a common material, an adhesive and a backing material; providing a committed set of instructions, where the committed set of instructions guides a cutting device; creating one or more voids of desired size and shape in the common material; inserting the inlay material into the one or more voids; and adhering the backing material to the inlay and at least some, but not all, of the common material by the adhesive, wherein at least one of the following is true: (i) the inlay material and common material are not adhered to one another and (ii) the inlay material and common material are not mechanically interconnected to one another, where the adhering includes applying one or both of heat and pressure to one or both of melt at least some of the adhesive and C-stage at least some, if not all, of the adhesive.

Some embodiments include, a method of making a decorative inlay by providing a inlay material, a common material, an adhesive in the form of a pre-formed, free-standing adhesive film and a backing material; providing a committed set of instructions, where the committed set of instructions guides a cutting device; creating one or more voids of desired size and shape in the common material; inserting the inlay material into the one or more voids; and adhering the backing material to the inlay and at least some, but not all, of the common material by the adhesive, wherein at least one of the following is true: (i) the inlay material and common material are not adhered to one another and (ii) the inlay material and common material are not mechanically interconnected to one another.

Some embodiments include, a method of making a decorative inlay by providing a inlay material, a common material, an adhesive and a backing material; providing a committed set of instructions, where the committed set of instructions guides a cutting device selected from the group consisting of a laser-cutting device, a mechanical-cutting device, a die, a hot wire-cutting device, a water jet or combination thereof; creating one or more voids of desired size and shape in the common material; inserting the inlay material into the one or more voids; and adhering the backing material to the inlay and at least some, but not all, of the common material by the adhesive, wherein at least one of the following is true: (i) the inlay material and common material are not adhered to one another and (ii) the inlay material and common material are not mechanically interconnected to one another.

Some embodiments include, a method of making a decorative inlay by providing a radio frequency molded polymeric inlay material, a leather common material, an adhesive and a backing material; providing a committed set of instructions, where the committed set of instructions guides a cutting device; creating one or more voids of desired size and shape in the common material; inserting the inlay material into the one or more voids; and adhering the backing material to the inlay and at least some, but not all, of the common material by the adhesive, wherein at least one of the following is true: (i) the inlay material and common material are not adhered to one another and (ii) the inlay material and common material are not mechanically interconnected to one another.

Some embodiments include, a method of making a decorative inlay by providing a inlay material having an inlet material thickness, a common material having a common material thickness, where the inlay thickness and common material thickness differ by no more than 5%, an adhesive and a backing material; providing a committed set of instructions, where the committed set of instructions guides a cutting device; creating one or more voids of desired size and shape in the common material; inserting the inlay material into the one or more voids; and adhering the backing material to the inlay and at least some, but not all, of the common material by the adhesive, wherein at least one of the following is true: (i) the inlay material and common material are not adhered to one another and (ii) the inlay material and common material are not mechanically interconnected to one another.

In some embodiments, the method further includes the inlay material having a desired pattern, and the determining the desired pattern and committing and translating the desired pattern into a committed set of instructions.

In some embodiments, the method further includes applying one or both of heat and pressure to one or both of melt at least some of the adhesive and C-stage at least some, if not all, of the adhesive during the adhering step.

In some embodiments, the method further includes providing the adhesive is in the form of a pre-formed, free-standing adhesive film.

In some embodiments, the method further includes the cutting device being selected from the group consisting of a laser-cutting device, a mechanical-cutting device, a die, a hot wire-cutting device, a water jet or combination thereof.

In some embodiments, the method further includes the inlet material being a radio frequency molded polymeric material.

In some embodiments, the method further includes the common material being leather.

In some embodiments, the method further includes the inlay material having an inlay material thickness and the common material having a common material thickness. Generally, the inlay material thickness and common material thickness differ by no more than about 5%.

In some embodiments, the common material thickness is greater than the inlay material thickness. Generally, the common material thickness is greater than the inlay material thickness and the common material thickness and inlay material thickness differ by no more than about 5%.

As used herein, the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

“Adhesive” generally refers to a composition comprising homopolymers, copolymers or polymer alloy comprising one or more of polyolefins, polystyrenes, polyvinyls, polyacrylics, polyhalo-olefins, polydienes, polyoxides, polyesthers, polyacetals, polysulfides, polythioesters, polyamides, polythioamides, polyurethanes, polythiourethanes, polyureas, polythioureas, polyimides, polythioimides, polyanhydrides, polythianhydrides, polycarbonates, polythiocarbonates, polyimines, polysiloxanes, polysilanes, polyphosphazenes, polyketones, polythioketones, polysulfones, polysulfoxides, polysulfonates, polysulfoamides, polyphylenes, and combinations and/or mixtures thereof. More specifically in a preferred embodiment, the thermoplastic adhesive composition comprises one of acrylonitrile butadiene styrene, acrylic (PMMA), celluloid, cellulose acetate, cyclo-olefin copolymer, ethylene-vinyl acetate (EVA), ethylene vinyl alcohol (EVOH), fluoroplastic (PTFE, FEP, PFA, CTFE, ECTFE, and/or ETFE), ionomer, liquid crystal polymer (LCP), polyacetal (POM and/or acetal), polyacrylate (acrylic), polyacrylonitrile (PAN or acrylonitrile), polyamide (PA or nylon), polyamide-imide (PAI), polyaryletherketone (PAEK and/or ketone), polybutadiene (PBD), polybutylene (PB), polybutylene terphthalate (PBT), polycaprolactone (PCL), polychlorotrifluoroethylene (PCTFE), polyethylene terephthalate (PET), polycycloheylene dimethylene terephthalate (PCT), polycarbonate (PC), polyhydroxylalkanoate (PHA), polyketone (PK), polyester, polyethylene(PE), polyetherketoneketone (PEKK), polyetherimide (PEI), polyethersulfone (PES), polysulfone, polyethlenechloriate (PEC), polyimide, polyacetic acid (PLA), polymethylpentene (PMP), polyphenylene oxide (PPO), polyphylene sulfide (PPS), polyphthalamide (PPA), polypropylen (PP), polystyrene (PS), polsulfone (PSU), polytrimethylen terphthalate (PTT), polyurethane (PU), polyvinyl acetate (PVA), polyvinyl chloride (PVC), polyvinylidene chloride (PVDC), styrene-acrylonitrile (SAN), and combinations thereof. The adhesive may be one of a thermosetting adhesive, a thermoplastic adhesive, a substantially A-staged thermosetting adhesive, a substantially B-staged thermosetting adhesive, a self-supporting adhesive film, a bi-laminate adhesive film having first and second adhesive layers, the first adhesive layer and second adhesive layer differing in one or both of chemical composition and physical properties, a tri-laminate adhesive film having a polymeric film positioned between a first adhesive film and a second adhesive film, a fast flow, low-melt adhesive, a hot-melt adhesive; and a combination and/or mixture thereof. Further regarding the tri-laminate adhesive film, the first adhesive film and second adhesive film may differ in one or both of chemical composition and physical properties, or have substantially the same chemical composition and physical properties, and the polymeric film may comprise one or more of an elastomeric material, a substantially inelastic material, clear, opaque, colored, uncolored, or a combination thereof. The polymeric film may be a tie layer.

A “metallized material” generally refers to one or more of a polymeric composition-containing metallized particles, a polymeric composition having a metallized coating, a polymeric composition having a metallized appearance, a metal-containing composition, and a combination and/or mixture thereof. The metallized material may comprise a molded polyurethane or silicone. Typically, the metallized material comprises molded polyurethane formed by high-frequency molding and/or shaping processes. More typically, the metallized material comprises molded metal-containing polyurethane formed by high-frequency molding and/or shaping processes. The high frequency molding process is commonly a radio frequency molding process. The molded polyurethane may have a single metallic hue. The metal may be any metal. Generally, the metal is silver, nickel, aluminum, or alloys and combinations thereof. The metal may be encapsulated and/or dispersed in the polymeric material. The metal may be coated to provide for additional and/or different hues. For example, the metal can be coated with yellow hue to provide for a gold look, or dark orange for copper look. Commonly, the metal may be encapsulated and/or dispersed in the polyurethane. While not wanting to be limited by example, the metal may be encapsulated and/or dispersed between two polymeric film layers. The metallized material may or may not include an adhesive layer. The metallized material typically has a metallic surface or metallic-like appearing surface and an opposing surface. The opposing surface may or may not include the adhesive layer. The adhesive layer can be in the form of an adhesive film layer. The metallic-appearing surface is commonly in the form of three-dimensional surface. The three-dimensional surface is formed during the high frequency molding process. Furthermore, edges of the metallized material can formed during the molding process. That is, the edges may be formed using a combination of high frequency energy and/or heat. Furthermore, the edges may be formed during the molding process by the mold die, specifically by the edge of the mold die and the pressure applied during the molding process. The molding process may or may not include welding a textile base to metallized material. Commonly, the metallized material is provided without a textile base. However, when provided with a textile base, the textile base is part of the metallized material. That is, the textile base of the metallized material is not a decorative element as used herein, other than that of the metallized material the textile base is molded thereto. More specifically, the high frequency molding process cannot cut through polymeric materials having a melting point greater than nylon and/or polyester. The metallized material can be one or more of pliable, soft and washable. More specifically, the metallized material can be laundered with clothing.

“Polymer,” “polymeric,” or “polymer composition” generally refers to a molecule comprising a plurality of repeating chemical groups, typically referred to as monomers. Polymers include man-made polymers, natural polymers and mixtures thereof. Polymers are often characterized by high molecular masses. Useful polymers include organic polymers and inorganic polymers both of which may be in amorphous, semi amorphous, crystalline, partially crystalline states, or combinations thereof. Polymers may comprise monomers having the same chemical composition or may comprise a plurality of monomers having different chemical compositions, such as a copolymer. Cross-linked polymers have linked monomer chains. Useful polymers include but are not limited to plastics, elastomers, thermoplastic elastomers, elastoplastics, thermosets, thermoplastics and acrylates. Exemplary polymers include but are not limited to acetal polymers, biodegradable polymers, cellulosic polymers, epoxies, fluoropolymers, polyolefins, polystyrenes, polyvinyls, polyacrylics, polyhalo-olefins, polydienes, polyoxides/esthers/acetals, polysulfides, polyesters/thioesters, polyamides/thioamides, polyurethanes/thiourethanes, polyureas/thioureas, polyimides/thioimides, polyanhydrides/thianhydrides, polycarbonates/thiocarbonates, polyimines, polysiloxanes/silanes, polyphosphazenes, polyketones/thioketones, polysulfones/sulfoxides/sulfonates/sulfoamides, polyphylenes, nylons, polyacrylonitrile polymers, polyamide, imide polymers, polyimides, polyarylates, polybenzimidazole, polybutylene, polycarbonate, polyesters, polyetherimide, polyethylene, polyethylene copolymers and modified polyethylenes, polyketones, poly(methyl methacrylate), polymethylpentene, polyphenylene oxides and polyphenylene sulfides, polyphthalamide, polypropylene, polyvinyls, polyurethanes, natural and synthetic rubber, silicones, styrenic resins, sulfone based resins, vinyl based resins and any combinations of these.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The preceding is a simplified summary to provide an understanding of some aspects of the present disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the present invention(s). These drawings, together with the description, explain the principles of the invention(s). The drawings simply illustrate preferred and alternative examples of how the invention(s) can be made and used and are not to be construed as limiting the invention(s) to only the illustrated and described examples.

Further features and advantages will become apparent from the following, more detailed, description of the various embodiments of the invention(s), as illustrated by the drawings referenced below.

FIG. 1 depicts an inlay of the prior art;

FIG. 2 depicts another inlay of the prior art;

FIG. 3 depicts yet another inlay of the prior art;

FIG. 4 depicts a cross-sectional view of a decorative inlay according to some embodiments of the present disclosure;

FIG. 5 depicts a top elevation view of an inlay according to some embodiments of the present disclosure;

FIG. 6 depicts a bottom elevation view of an inlay according to some embodiments of the present disclosure; and

FIG. 7 depicts a process for making an inlay according to some embodiments of the present disclosure.

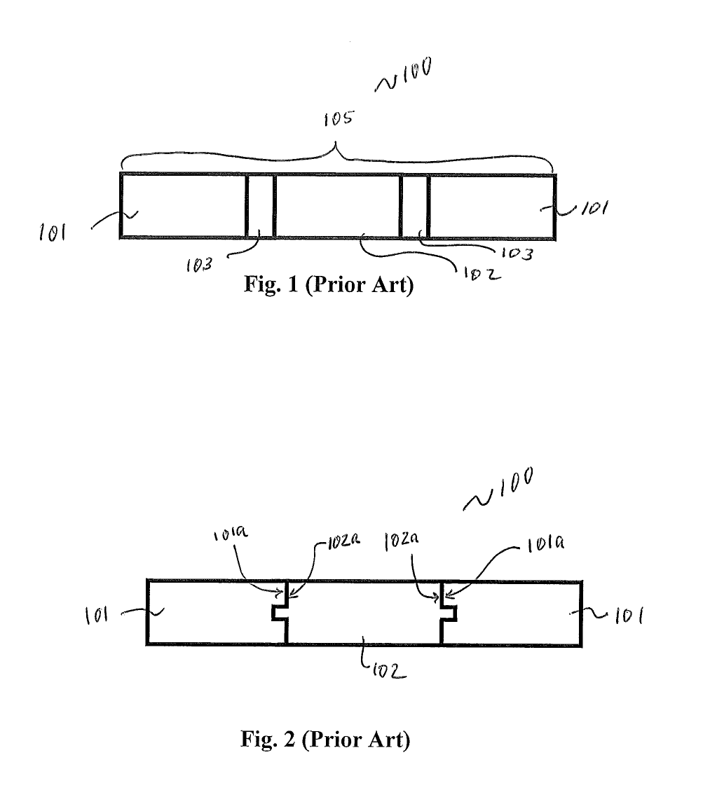

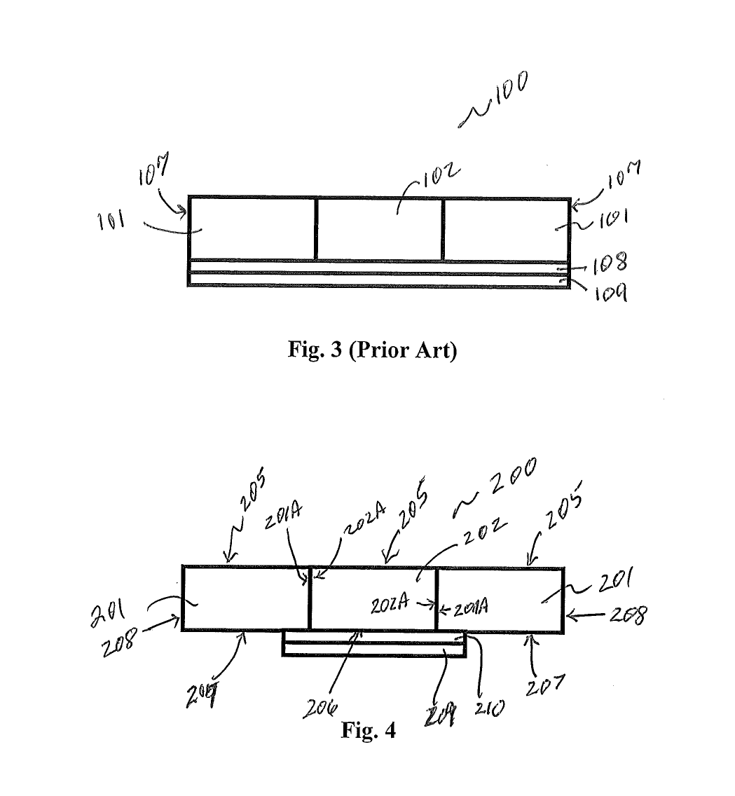

### DETAILED DESCRIPTION

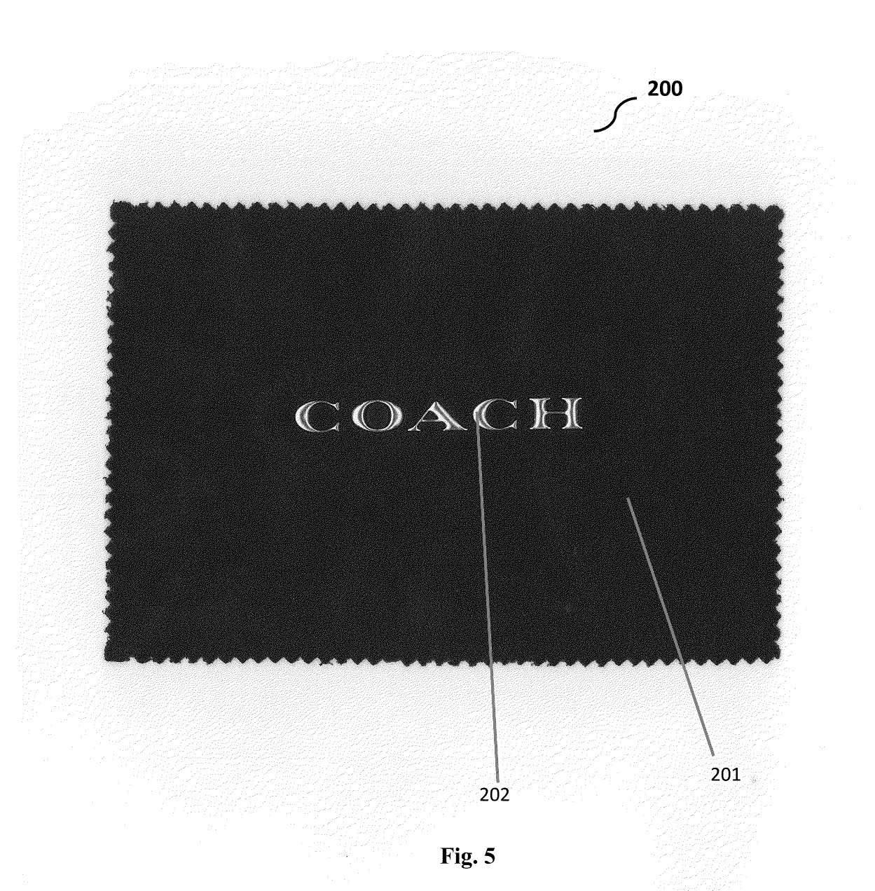

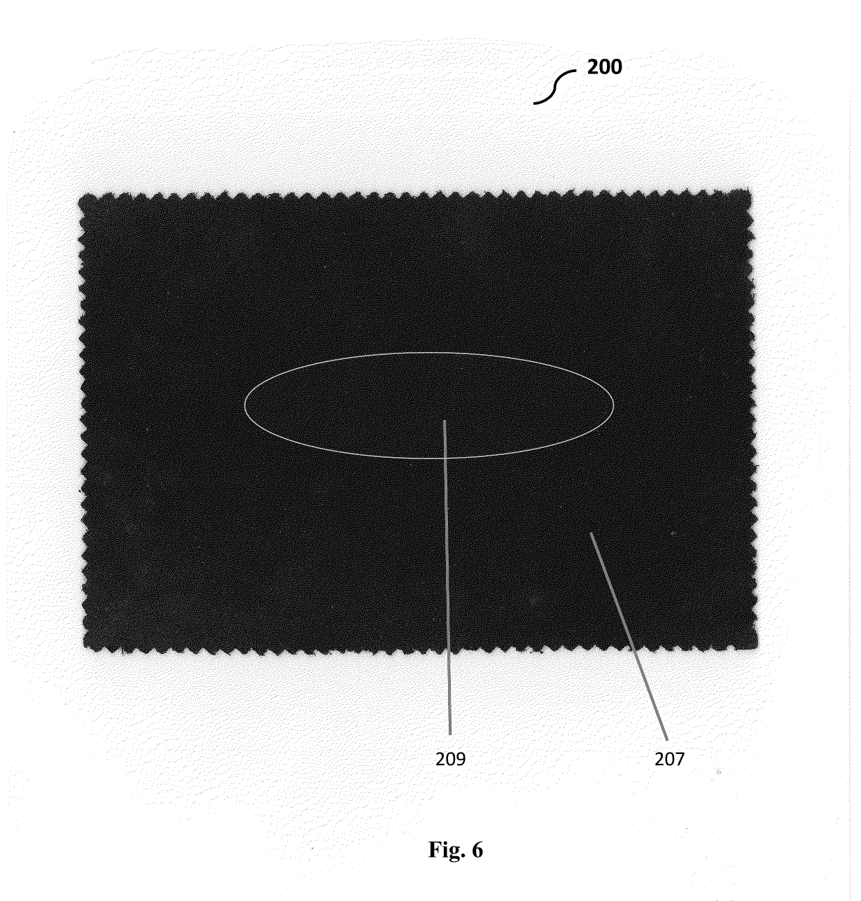

The present disclosure is to a novel decorative inlay assembly 200 and a method of making the same. The decorative inlay 200 comprises a common material 201 and an inlay material 202 (FIGS. 4-6). The insert material 202 and common material 201 are difficult to or incapable of being mechanically interlocked. Moreover, the insert material 202 and common material 201 are difficult to or incapable of being adhesively joined.

The common material 201 typically comprises a non-rigid material, such as, but not limited to a natural animal skin (such as, leather, snake skin, ostrich skin, and such) or a polymeric layer. The inlay material 202 typically comprises a polymeric material, a metalized material, a flock, a woven material, knitted material, or a combination thereof. More typically, the inlay material 202 is at one of a polymeric material or a metalized material, even more typically the inlay material 202 is a metalized material. The metalized material can be a radio frequency molded polymeric material. Commonly, the radio frequency molded polymeric material is radio frequency molded polyurethane. Non-limiting examples of inlay materials, in particular polymeric inlay materials, are discussed in U.S. patent application Ser. No. 13/625,797 filed Sep. 24, 2012 and entitled “Hybrid Mixed Media Decorative Articles and Methods for Making the Same” and Ser. No. 14/053,399 filed Oct. 14, 2013 and entitled “Flexible Heat Sealable Decorative Articles and Method for Making the Same”, each of which is incorporated in its entirety by this reference.

The inlay material 202 and the common material 201, respectively have an inlay thickness and common material thickness. Commonly, the inlay thickness and common material thickness are identical. More commonly, the inlay material 202 and common material 201 commonly have about the same thickness. Even more commonly, the common material thickness is greater than the inlay material thickness.

In some embodiments, inlay thickness and common material thickness differ to achieve a greater three-dimensional affect. Typically, the inlay material thickness and common material thickness differ by no more than about 1%, more typically by no more than about 5%, even more typically by no more than about 10%, yet even more typically by no than about 20%, or even yet more typically by no than about 30%.

The inlay material 202 has a desired pattern. The desired pattern can have the shape of a graphic design element (such a team logo, a product logo, or such), a series of alphanumeric characters or such. The desired pattern is committed and translated to a set of instructions. The committed set of instructions is suitable for operating a cutting device. The cutting device can be a laser-cutting device, a mechanical-cutting device (such a die), a hot wire-cutting device, a water jet or combination thereof. The committed set of instructions guides the cutting device, creating one or more voids of desired size and shape in the common material 201. The one or more voids correspond to the desired pattern of the inlay material 202.

The inlay material 202 is then inserted into the one or more voids contained in the common material 201. The fit of the inlay material 202 in the one or more voids is precise and snug. That is, when the inlay material 202 is positioned in the one or more voids of the common material 201, any gap between the inlay material 202 and the common material 201 is commonly no more than about 1 mm, more commonly no more than about 0.5 mm, even more commonly no more than about 0.2 mm, yet even more commonly no more than about 0.1 mm, or still yet even more commonly no more than about 0.05 mm.

The inlay material 202 and common material 201 are position with one or more inlay material sides or ends 202A and common material sides or ends 201A positioned adjacent to one another. The one or more inlay and common material sides or ends positioned adjacent to one another are devoid of any mechanical interlocking of the inlay material 202 with common material 201.

The gap between the inlay material 202 and common material 201 is devoid of any adhesive. That is, gap between the inlay material 202 and common material 201 is free of any adhesive. Stated another way, the one or more inlay and common material sides or ends positioned adjacent to one another are devoid and free of any adhesive.

Commonly, the gap between the inlay material 202 and common material 201 is free of any adhesive and mechanical interlocking More commonly, the gap between the inlay material 202 and common material 201 is no more than about 1 mm and free of any adhesive and mechanical interlocking Even more commonly, the gap between the inlay material 202 and common material 201 is no more than about 0.5 mm and free of any adhesive and mechanical interlocking. Yet even more commonly, the gap between the inlay material 202 and common material 201 is no more than about 0.1 mm and free of any adhesive and mechanical interlocking. It can be appreciated that decorative inlays 202 constructed free of one or both of mechanically interlocking and an adhesive positioned between the inlay material and the common material reduces stiffness or rigidity of the decorative inlay.

The common material 201 and the inlay material 202 positioned in the one or more voids comprise a viewable surface 205. Opposing the viewable surface 205 are inlay back surface 206 and common material back surface 207. The common material 201 has an outer perimeter 208. A backing material 209 is adhered to the inlay material 202 and common material 201. The baking material 209 adhered to the common material 201 does not extend to the outer perimeter 208. Furthermore, a first portion of the base material is in contact with all of the inlay back surface 206 and a second portion of the base material is in contact with some, but not all, of the common material back surface 207. The decorative assembly 200 is adhered to the inlay material 202 and the common material 201 by adhesive 210. It can be appreciated that a decorative inlay having a backing material 209 that extends over some, but not all, of the common material one or more of decreases bulkiness, reduces rigidity, and expands design features of decorative inserts.

The backing material 209 can be any polymeric material. The backing material 209 can be in the form of one of a polymeric film, a woven textile material, a knitted textile material, a non-woven textile material, or a combination thereof. In some configurations the backing material can a natural animal skin, such as, but not limited to leather. In some configurations, the backing material 209 is provided with adhesive 210.

Typically, the common material 201 is in contrast to the inlay material 202. Moreover, the common material 201 is an apparent background for the inlay material 202. The overall effect is of a pleasing viewable surface 205 which can take a wide variety of forms, and one of which the fit between the inlay material 202 and common material 201 is precise and aesthetically pleasing.

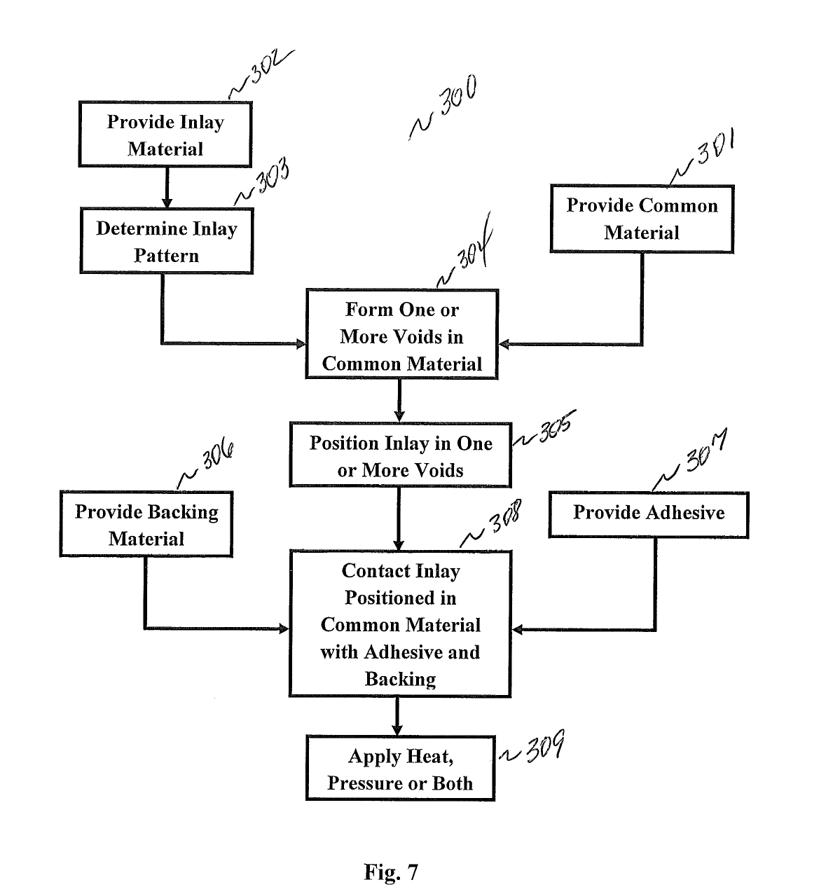

FIG. 7 depicts a process 700 for making a decorative inlay 200 (FIGS. 4-6).

In step 301, a common material 201 is provided. The common material 201 can be any common material described within this disclosure.

In step 302, an inlay material 202 is provided. The inlay material 202 can be any inlay material described within this disclosure.

In step 306, a backing material 209 is provided. The backing material 209 can be any backing material described within this disclosure.

In step 307, an adhesive 210 is provided. The adhesive 210 can be any adhesive described within this disclosure.

In optional step 303, the inlay material 202 pattern is determined. The pattern is committed and translated to a set of instructions. The committed set of instructions is suitable for operating a cutting device. The cutting device can be any cutting device described within this disclosure.

In step 304, the committed set of instructions guides the cutting device, creating one or more voids of desired size and shape in the common material 201. The one or more voids correspond to the pattern of the inlay material 202.

In some configurations, step 204 includes providing a committed set of instructions are provided. The committed set of instructions guides the cutting device, creating one or more voids of desired size and shape in the common material 201. The one or more voids correspond to the pattern of the inlay material 202.

In step 305, the inlay material 202 is inserted into the one or more voids contained in the common material 201. The fit of the inlay material 202 in the one or more voids is precise and snug. Typically, the inlay material 202 and common material 201 are position with one or more inlay 202 and common 201 material sides or ends positioned adjacent to one another. More typically, the one or more inlay 202 and common material 201 sides or ends positioned adjacent to one another are devoid of one or both of any mechanical interlocking of the inlay material 202 with common material 201 and any adhesive positioned between the inlay material 202 and common material 201.

In step 308, the adhesive 210 is one or more of: (a) positioned between the backing material 209 and both of the inlay material 202 and common material 201; (b) contacted with the backing material 209; and (c) contacted with the inlay material 202 and common material 201. The adhesive 210 can be positioned, contacted, or both in registration with one or more of the backing material 209, inlay material 202 and common material 201. The adhesive can be a pre-formed, free-standing adhesive film. The adhesive can be contacted with one or more of the backing material 209, inlay material 202 and common material 201 by one of more of screen-printing, spraying, gluing line, printing process or such.

In step 309, the backing material 209 is adhered by adhesive 210 to the inlay material 202 and some, but not all, of the common material 201. The decorative inlay 2100 is formed by adhering the backing material 209 to inlay material 202 and some, but not all, of the common material 201. Step 309 can include applying one or both of heat and pressure during the process of adhering the backing material 209 to the inlay material 202 and some, but not all, of the common material 201. Moreover, step 309 can include applying sufficient heat to melt at least some of the adhesive 210 during the process of adhering the backing material 209 to the inlay material 202 and some, but not all, of the common material 201. Furthermore, step 309 can include C-staging at least some, if not all, of the adhesive 210 during the process of adhering the backing material 209 to the inlay material 202 and some, but not all, of the common material 201.

Another embodiment of the present is directed to applying decorations or decorative article, such as stickers, adhesive badges, emblems, patches, tags, insignia, plates, stamps, banners, images, markings, (identification) labels, and other decorations and decorative articles to vinyl materials, such as a bag, suitcase, clothing, headware, gloves, shoes, upholstery, sheets, and other articles, such as polymeric articles. The polymeric articles can comprise polymerized vinyl. “Vinyl” can refer to the univalent chemical radical CH₂CH derived from ethylene, to any of various compounds containing the vinyl radical, which compounds are typically highly reactive, easily polymerized, and used as basic materials for plastics, and to any resin formed by polymerization of compounds containing the vinyl group or plastics made from such resins. In its polymerized form vinyl can refer to polymers containing the (—CX¹X²CX³X⁴—)ₙ repeating unit, where X¹, X², X³, X⁴ can be the same or differ one from the other (X can be without limitation H, Cl, F, Br, CH₃, C₆H₅, and so forth). An example vinyl article is a transparent bag. The decorations or decorative articles can have one or more decorative media, such as metallic and nonmetallic films and layers, flock, woven and nonwoven textiles, embroidery, glass beads, and the like. Non-limiting examples of such decorations or decorative articles are discussed in U.S. patent application Ser. No. 13/625,797 filed Sep. 24, 2012 and entitled “Hybrid Mixed Media Decorative Articles and Methods for Making the Same” and Ser. No. 14/053,399 filed Oct. 14, 2013 and entitled “Flexible Heat Sealable Decorative Articles and Method for Making the Same”, each of which is incorporated in its entirety by this reference.

The decorations or decorative article can include an adhesive, such as a pressure sensitive adhesive, and the vinyl material one or more perforations where the decoration or decorative article is to be adhered. Optionally, a backing material, also having an adhesive, is positioned opposite to the decoration or decorative article, such that the vinyl material is positioned between the backing material and the decoration or decorative article. The adhesive-to-adhesive contact via the one or more perforations (which pass through the vinyl material) can provide a strong bond.

A number of variations and modifications of the present disclosure can be used. It would be possible to provide for some features of the disclosure without providing others.

The present disclosure, in various embodiments, configurations, or aspects, includes components, methods, processes, systems and/or apparatus substantially as depicted and described herein, including various embodiments, configurations, aspects, sub-combinations, and subsets thereof. Those of skill in the art will understand how to make and use the present disclosure after understanding the disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion has been presented for purposes of illustration and description. The foregoing disclosure is not intended to be limiting to the form or forms disclosed herein. In the foregoing Detailed Description for example, various features are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that one or more of the claims require more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. An article, comprising:
a backing material;
a common material; and
an inlay material; wherein the common material is adhered to the backing material and supports the backing material and wherein at least one of the following is true: (i) the inlay material and common material are not adhered to one another and (ii) the inlay material and common material are not mechanically interconnected to one another.

2. The article of claim 1, wherein the inlay is a polymeric material.

3. The article of claim 1, wherein the inlay is a radio frequency molded polymeric material.

4. The article of claim 1, wherein the common material is a naturally occurring animal skin.

5. The article of claim 1, wherein the common material is leather.

6. The article of claim 1, wherein the common material has one or more voids and wherein the inlay material is positioned in the one or more voids.

7. The article of claim 1, wherein the common material has a common material thickness, wherein the inlay material has an inlay material thickness and wherein the common material thickness and inlay material thickness are about equal.

8. An article of decoration, comprising:
an inlay material;
a common material having one or more voids containing the inlay material; and
a backing material, wherein the inlay material is adhered to a first portion of the backing material, wherein a second portion of the backing material is adhered to some, but not all, of the common material, and wherein at least one of the following is true: (i) the inlay material and common material are not adhered to one another and (ii) the inlay material and common material are not mechanically interconnected to one another.

9. The article of claim 8, wherein the inlay is a polymeric material.

10. The article of claim 8, wherein the inlay is a radio frequency molded polymeric material.

11. The article of claim 8, wherein the common material is a naturally occurring animal skin.

12. The article of claim 8, wherein the common material is leather.

13. The article of claim 8, wherein the common material has a common material thickness, wherein the inlay material has an inlay material thickness and wherein the common material thickness and inlay material thickness are about equal.

14. A method, comprising:
providing a inlay material, a common material, an adhesive and a backing material;
providing a committed set of instructions, wherein the committed set of instructions guides a cutting device, creating one or more voids of desired size and shape in the common material;
inserting the inlay material into the one or more voids;
adhering the backing material to the inlay and at least some, but not all, of the common material by the adhesive, wherein at least one of the following is true: (i) the inlay material and common material are not adhered to one another and (ii) the inlay material and common material are not mechanically interconnected to one another.

15. The method of claim 14, wherein the inlay material has a desired pattern, and further comprising:
determining the desired pattern; and
committing and translating the desired pattern into a committed set of instructions.

16. The method of claim 14, wherein the adhering step further comprises:
applying one or both of heat and pressure to one or both of melt at least some of the adhesive and C-stage at least some, if not all, of the adhesive.

17. The method of claim 14, wherein the adhesive is provided in the form of a pre-formed, free-standing adhesive film.

18. The method of claim 14, wherein the cutting device is selected from the group consisting of a laser-cutting device, a mechanical-cutting device, a die, a hot wire-cutting device, a water jet or combination thereof.

19. The method of claim 14, wherein the inlet material is radio frequency molded polymeric material and the common material is leather.

20. The method of claim 14, wherein the inlay material has an inlay material thickness, wherein the common material has a common material thickness, and wherein the inlay thickness and common material thickness differ by no more than about 5%.
